(19) United States
(12) Patent Application Publication
(10) Pub. No.: US 2014/0069509 A1
(43) Pub. Date: Mar. 13, 2014

(54) FLOW MONITORING SYSTEM, METHOD AND SOFTWARE

(71) Applicant: Chase Prescott Klicka, Brawley, CA (US)

(72) Inventor: Chase Prescott Klicka, Brawley, CA (US)

(21) Appl. No.: 14/025,405

(22) Filed: Sep. 12, 2013

Related U.S. Application Data
(60) Provisional application No. 61/700,314, filed on Sep. 12, 2012.

(51) Int. Cl. G05D 7/06

(52) U.S. Cl. CPC G05D 7/0617
USPC 137/2; 137/487.5

(57) ABSTRACT

A flow monitoring system, software, and method of use.

### FIELD OF THE INVENTION

The present invention relates generally to the field of liquid flow monitoring systems, the method of use of such a system and a software product to implement such a system.

### BACKGROUND OF THE INVENTION

Current farming techniques include the application of both water and fertilizer.

Fertilization systems generally fall within two categories, namely, dry and waterborne systems. Waterborne systems are particularly convenient and effective in certain applications. For example, conventional waterborne fertilizer distribution systems are generally simply attached in line with conventional watering systems. In addition, users generally need not come in contact with the fertilizer and the waterborne fertilizer is readily absorbed by leaves of plants and/or into the ground where it is made available to roots of the plants.

However, in conventional waterborne fertilizer distribution systems, it is a disadvantage that the fertilizer contains particulates and may have a tendency to clump or aggregate. Current distributions systems are known to become blocked and the outlets clog causing uneven distribution of liquid fertilizer and potential damage to both crops and equipment. Because of the geographical scope and number of distribution systems, these blockages or uneven flows may go untended for extended periods time. Thus, a user is required to physically monitor the flow on a regular basis, physically start and stop the flow and/or make physical adjustments to the flow and more time is required to re-distribute the fertilizer over the areas of uneven distribution or flow. Therefore, it is desirable to provide a fertilizer distribution system which allows for remote monitoring of the flow of the liquid fertilizer, and a method of use that is capable of overcoming the disadvantages described herein at least to some extent.

### SUMMARY OF INVENTION

The present invention comprises a flow monitoring system and method of using the same, which enables a user to remotely monitor, start, stop, and adjust the flow of a liquid based on desired flow characteristics.

In one or more embodiments, the flow monitoring system may consist of a liquid fertilizer out-flow monitor, a means for transmitting the status of the flow, a means for starting and stopping the flow, and a means for adjusting the flow content and rate of the liquid fertilizer.

In one or more embodiments, the flow monitoring system may include an out-flow monitor which is a transduction type monitor.

In one or more embodiments, the flow monitoring system may include in out-flow monitor which is a pass-through type of monitor.

In one or more embodiments, the flow monitoring system may include an out-flow monitor which is a gravimetric type of monitor.

In one or more embodiments, the flow monitoring system may include an out-flow monitor which can test the content of the flow.

In one or more embodiments, the flow monitoring system may include a means for transmitting the status of the flow, wherein the means may be based on a radio frequency communications system.

In one or more embodiments, the flow monitoring system may include a means for transmitting the status of the flow, wherein the means may be based on a wireless communications system.

In one or more embodiments, the flow monitoring system may include a means for transmitting the status of the flow, wherein the means may be based on a networked computer communications system.

In one or more embodiments, the flow monitoring system may include means for transmitting the status of the flow, wherein the means may be based on a satellite communications system.

In one or more embodiments, the flow monitoring system may be controlled by a computer or computer-like device.

In one or more embodiments, the computer, or computer-like device, may include without limitation, a desktop computer, a laptop, tablet, PDA, smart phone, or other electronic device which allows for a user interface such that selection choices may be made through the user interface.

In one or more embodiments, the computer, or computer-like device, may be a stand-alone device, a networked device, whether wired or wireless, or other similarly connected or connectable device.

In one or more embodiments, the computer, or computer-like device, includes a user interface.

In one or more embodiments, the software driving the user interface may be hosted on the user's computer, or computer-like, device, on a network or central server, or it may be cloud-based in an SaaS or similar format.

One or more embodiments comprise a method of using the system.

One or more embodiments comprise a software product to implement the described system. The software product further comprising a non-transitory computational device-readable medium in which program instructions are stored, which instructions, when read by at least a first computational device, cause the computational device to receive flow data, compare the flow data using at least a first desired characteristic; allow user adjustment of the at least a first desired characteristic and produce a report configured to confirm successful adjustment of the at least first desired characteristic.

With respect to the above description then, it is to be realized that the optimum characteristics, criteria and interrelationships for the parts of the invention, to include variations in type, number, specific criteria, form, function and manner of use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Other objectives, features and advantages of the invention will become apparent from the following description and drawings wherein.

### BRIEF DESCRIPTION OF THE DRAWINGS

FIG. 1 is a graphical depiction of the Flow Monitoring System.

FIG. 2 is a graphical depiction of the functional modules of the Flow Monitoring Unit.

### DETAILED DESCRIPTION OF THE PREFERRED EMBODIMENT

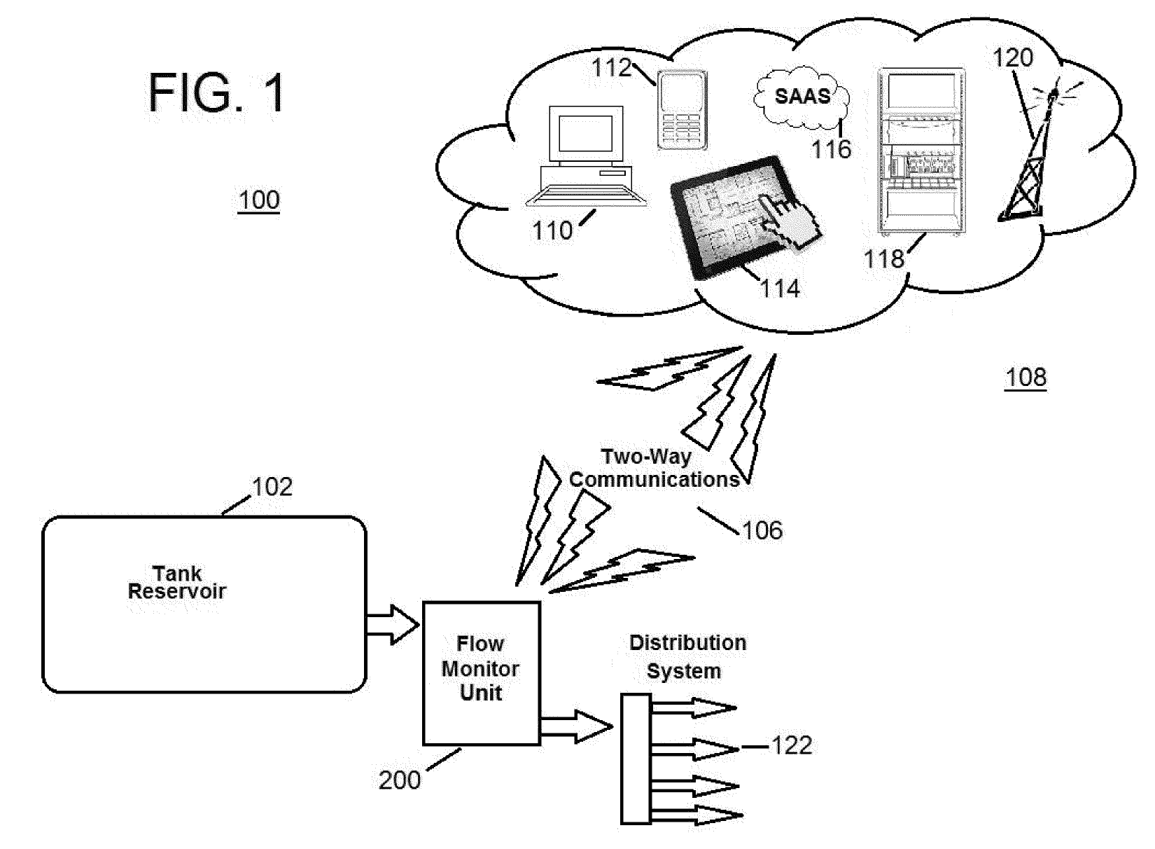

Referring now to FIG. 1, a flow monitoring system 100, may be comprised of a tank reservoir 102, a flow monitor unit 200, a distribution system 122, and a communications device or method 108.

The flow monitor unit 200 is attached to the outflow of the tank reservoir 102. The flow monitor unit 200 is connected through two-way communications 106 with a communications device or method 108. The result of those two-way communications 106 may result in a change of flow from the flow monitor unit 200 to the distribution system 122.

In one embodiment, the two-way communications 106 between the flow monitor unit 200 and a communications device or method 108 may be accomplished through direct channel communications, a network, whether wired or wireless, radio, satellite, or a combination of two or more of the previous types.

In one embodiment, communications device or method 108 may be comprised of one or more of the following types of devices: a desktop computer 110, a smart phone 112, a tablet computer 114, a cloud-based communication system 116, a server array 118, or through radiofrequency devices 120. These communication devices or methods 108 may be stand-alone, on a local network, or on a distributed network.

A user using one of the communication devices or methods 108 may, through the use of two-way communications with the flow monitor unit 200, monitor, start, stop, and adjust the flow from the tank reservoir 102 to the distribution system 122.

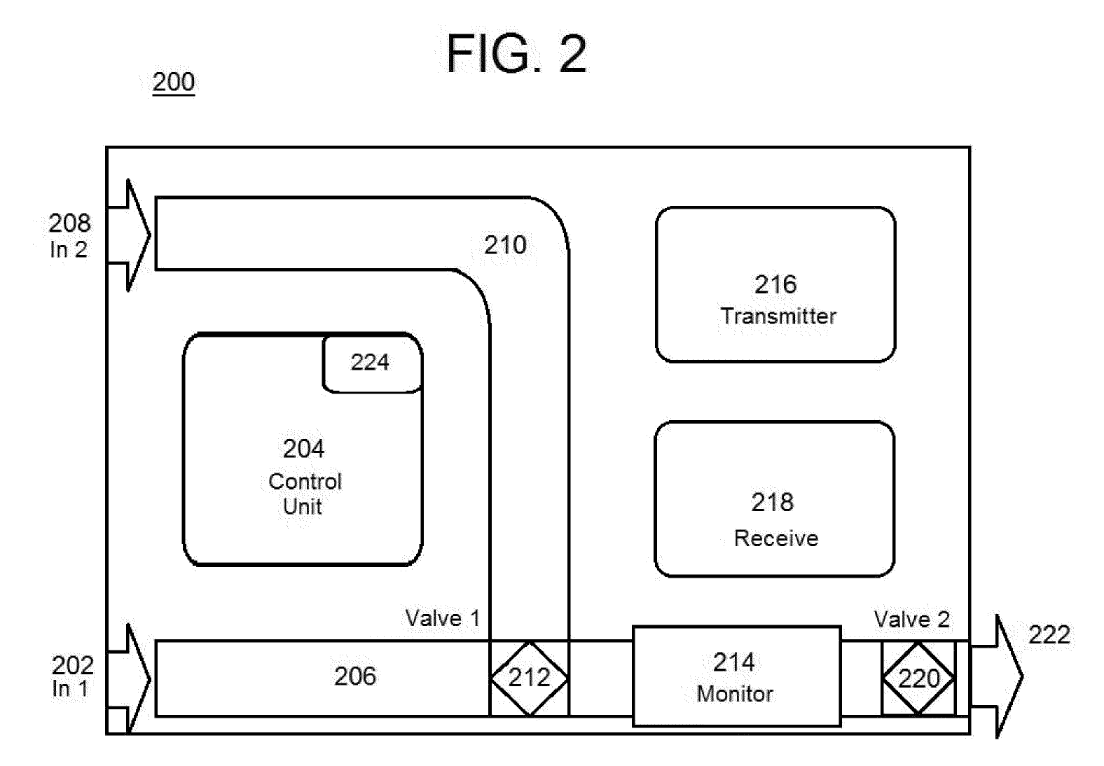

Referring now to FIG. 2, the flow monitoring unit 200 may be comprised of a first input 202, a second input 208, a flow monitor 214, an output 222, a means of transmitting 216 and receiving 218 communications from a user and a control unit 204 to allow the flow monitor unit 200 to carry out those communications.

In one embodiment, interior piping or channeling means 206 for the first input 202, and interior piping or channeling means 210 for the second input 208 are joined by a first valve 212. The first valve 212 may allow for a separate or combined flow from the first input 202 and the second input 208 according to the user's choice or criteria.

The flow resulting from the first valve 212 then passes in, through, or by a flow monitor 214 which determines the characteristics of the flow. A flow which has desired characteristics may then pass through a second valve 220 and through the output 222.

If the flow coming from the first valve 212 is determined by the monitor 214 to not meet the desired characteristics then the flow may be altered at either the first valve 212 or the second valve 220.

In one embodiment, a user may query the flow monitoring unit 200 which receives the query through the receiver 218. The control unit 204 relays the status of the flow in, through, or by the monitor 214 and the status is then transmitted to the user using the transmitter 216. The user may then start, stop or adjust the characteristics of the flow utilizing on or both of the valves 212, 220.

In one embodiment, a user may query the flow monitoring unit 200 which receives the query through the receiver 218. The control unit 204 relays the status of the flow in, through, or by the monitor 214 and the status is then transmitted to the user using the transmitter 216. The user may then start, stop or adjust the content of the flow utilizing valve 212.

The new characteristics or content of the flow are then transmitted back to the user through the transmitter 216.

In one embodiment, the control unit 204 may include a separate memory module 224 to log events and communications.

While various embodiments of the disclosed system, software, and method have been described above, it should be understood that they have been presented by way of example only, and should not limit the claimed invention. Likewise, the various diagrams may depict an example architectural or other configuration for the disclosed system, software, and method. This is done to aid in understanding the features and functionality that can be included in the disclosed system, software, and method. The claimed invention is not restricted to the illustrated example architectures or configurations, rather the desired features can be implemented using a variety of alternative architectures and configurations. Indeed, it will be apparent to one of skill in the art how alternative functional, logical or physical partitioning and configurations can be implemented to implement the desired features of the disclosed system, software, and method. Also, a multitude of different constituent module names other than those depicted herein can be applied to the various partitions. Additionally, with regard to flow diagrams, operational descriptions and system or method claims, the order in which the steps are presented herein shall not mandate that various embodiments be implemented to perform the recited functionality in the same order unless the context dictates otherwise.

Although the disclosed system, software, and method is described above in terms of various exemplary embodiments and implementations, it should be understood that the various features, aspects and functionality described in one or more of the individual embodiments are not limited in their applicability to the particular embodiment with which they are described. Thus, the breadth and scope of the claimed invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

We claim:

1. A remote flow monitoring and control system comprising:
a. a means for transmitting the status of the flow;
b. a means for receiving remote instructions;
c. a means for starting and stopping the flow;
d. a means for adjusting the rate of flow;
e. a means for adjusting the content of the flow; and
f. a communications device with a user interface, wherein a user may monitor, start, stop and adjust characteristics of the flow.

2. A method of using the remote flow monitoring and control system of claim 1, comprising:
a. providing a means for transmitting the status of a flow;
b. providing the means for starting and stopping the flow;
c. providing the means for adjusting the rate of the flow;
d. providing the means for adjusting the content of the flow; and
e. providing a communications device with a user interface wherein a user may monitor, start, stop and adjust the characteristics of the flow.

3. A software product, comprising a non-transitory computational device-readable medium in which program instructions are stored, which instructions, when read by at least a first computational device, cause the computational device to receive flow data, compare the flow data using at least a first desired characteristic; allow user adjustment of the at least a first desired characteristic and produce a report configured to confirm successful adjustment of the at least first desired characteristic.
